(19) United States
(12) Patent Application Publication
(10) Pub. No.: US 2005/0246974 A1
(43) Pub. Date: Nov. 10, 2005

(54) Device and method for removal of burglar bars

(76) Inventor: Brian E. Anderson, Douglasville, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/824,783

(22) Filed: Apr. 15, 2004

(51) Int. Cl. E06B 7/00

(52) U.S. Cl. 52/155

(57) ABSTRACT

The present invention is a massive body having handles to facilitate maneuvering, and an attached chain. The chain can be attached quickly around burglar bar doors and/or windows and the massive body swung in such fashion as to rapidly carry the burglar bar door and/or window away from its supports. The present invention can then be carried on its return swing into the remaining entry door in much the same way as a conventional battering ram.

### TECHNICAL FIELD

The present invention relates generally to an apparatus and method for attaching to burglar bars for assistance in the removal thereof from over doors and/or windows.

### BACKGROUND OF THE INVENTION

Heightened security has caused many individuals to supplement their doors and windows with bar-like devices to prevent someone from unauthorized entry. Typically, the bar-like devices are constructed to form door and/or window shapes and are mounted exterior to the remaining conventional door and/or window. Generally, individuals installing such burglar bar doors and windows are law-abiding citizens concerned about entry by criminal elements. Occasionally, however, criminals also utilize such devices to impede entry of law enforcement personnel in order to increase time available to make an escape and/or to destroy evidentiary material.

Law enforcement officers need a method of entry through such burglar bar doors and windows that is rapid and easy to utilize. Heretofore, devices available to law enforcement officers have been cumbersome and difficult to use, and do not allow swift entry through such burglar bars.

There are various devices and methods available, all of which are disadvantageous, impractical and/or problematic. For example, battering ram devices have long been utilized for opening doors; however, they are not suitable for opening barred doors. Battering rams either pass through the openings in between the bars, or are deflected by the bars. Additionally, such devices require a perpendicular approach to a door in order to apply a battering force, and such is often not possible, as in the case of tight and/or narrow hallways. Moreover, to attempt to remove both a burglar bar door and a conventional door simultaneously with a battering ram compounds an altogether difficult problem.

Winch devices have occasionally been utilized to pull doors away from their frame. While such methods are suitable for removal of burglar bar doors in some instances, they typically require that the winch be located close to the door, have a straight path to the door, and be affixed to a rigid object. Use of truck-mounted winches rarely affords an opportunity for use to remove burglar bar doors, since positioning a truck near enough to the doors is typically impractical.

While some or all of the above-referenced devices may well be utilized for opening doors or even burglar bar doors and/or windows in some situations, each disadvantageously fails to adequately provide a device that can be readily maneuvered, handled and transported.

Therefore, it is readily apparent that there is a need for a novel device and method for removal of burglar bar doors, thereby enabling rapid, efficient removal of such doors and avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing a method and apparatus for swift removal of burglar bar doors and windows and/or further removal of any remaining conventional door or window once the burglar bar door has been removed.

According to its major aspects and broadly stated, the present invention in its preferred embodiment is a massive body having handles, to facilitate maneuvering, and an attached chain, wherein the chain can be quickly secured around burglar bar doors and/or windows and the massive body maneuvered in such fashion as to rapidly and forcibly remove the burglar bar door and/or window away from its supports. The device of the present invention can then be carried in a return motion into the remaining entry door in much the same way as a conventional battering ram.

Thus, the present invention relates to a device that could be utilized by law enforcement officers to quickly remove burglar bar doors and/or windows, and to subsequently rapidly enter through remaining entry doors. It is further suitable for facilitating quick entry by fire department personnel to save trapped people, children, pets, etc.

A feature and advantage of the present invention is its ability to be handled by a minimum complement of users.

A further feature and advantage of the present invention is that it is suitable for removing both burglar bar doors and burglar bar windows.

A feature and advantage of the present invention is that it is suitable for assistance in removing burglar bars and conventional entry doors.

A further feature and advantage of the present invention is its ease of manufacture and low cost of production.

A further feature and advantage of the present invention is that it can be readily transported in a passenger vehicle.

A feature and advantage of the present invention is that it can be utilized in tight hallways or otherwise constricted spaces.

Another feature and advantage of the present invention is its suitability to be made in different sizes and/or weights to meet the needs of removal of different strength burglar bars and/or doors.

These and other features and advantages of the present invention will become more apparent to one skilled in the art from the following description and claims when read in light of the accompanying drawings.

### BRIEF DESCRIPTION OF THE DRAWINGS

Having thus described the invention in general terms, the present invention will be better understood by reading the Detailed Description of the Preferred and Selected Alternate Embodiments with reference to the accompanying drawing figures, which are not necessarily drawn to scale, and in which like reference numerals denote similar structures and refer to like elements throughout, and in which:

FIG. 1 is a perspective view of the body of a device according to a preferred embodiment of the present invention;

FIG. 2A is a partial perspective view of the top of a device according to a preferred embodiment of the present invention, showing the chain;

FIG. 2B is a cutaway view of the top of a device according to an alternate embodiment of the present invention, showing the chain securing mechanism; and

FIG. 3 is a perspective view of a device according to a preferred embodiment of the present invention, showing the device in use.

### DETAILED DESCRIPTION OF THE PREFERRED AND ALTERNATIVE EMBODIMENTS

In describing the preferred and selected alternate embodiments of the present invention, as illustrated in the Figures, specific terminology is employed for the sake of clarity. The invention, however, is not intended to be limited to the specific terminology so selected, and it is to be understood that each specific element includes all technical equivalents that operate in a similar manner to accomplish similar functions.

The present invention arose from a need for a device and method for entry through burglar bar doors and windows in a rapid, easy fashion, in order to facilitate quick entry into a building protected therewith.

The present invention is suitable for, but not limited to, use by law enforcement personnel and other emergency personnel, such as, for exemplary purposes only, fire department personnel.

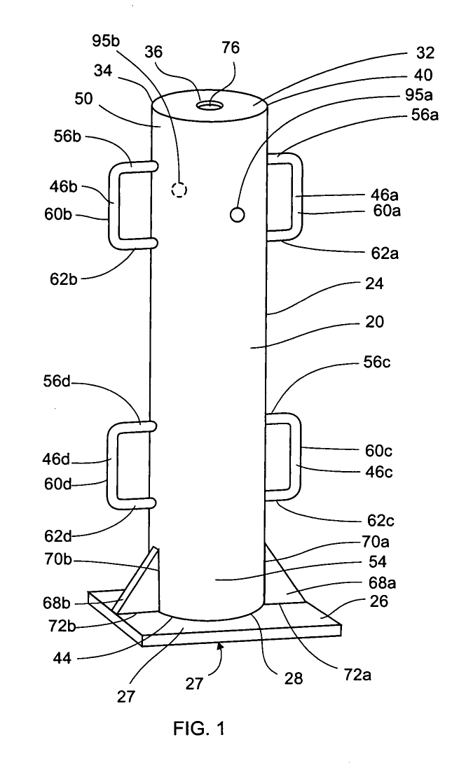

Referring now to FIGS. 1, 2A, and 3, apparatus 10 preferably has body 20, wherein body 20 is preferably generally cylindrically-shaped. It will be recognized by one skilled in the art that body 20 may take forms other than cylindrical and would still be within the confines of the present invention. To facilitate use of apparatus 10 in confined spaces, body 20 is preferably approximately thirty-six inches long; however, any length body could be utilized. Preferably, body 20 is somewhat weighty, whereby force applied thereby is maximized, but portability remains reasonable. Thus, preferably the weight of body 20 is between approximately thirty and approximately seventy pounds. The inventor has found that approximately fifty pounds affords the optimum balance between ability to apply force and transportability, when used in police applications. Although such weight is preferred, body 20 could have less or more weight, wherein effectiveness and/or portability would likely be influenced. Body 20 is preferably made from a high-strength, high-density material, such as, for exemplary purposes only, iron or steel, although other materials will be recognized as suitable. Moreover, any material, or combination of materials, capable of exhibiting strength under forceful pressure could be used to manufacture body 20. Apparatus 10 may be solid, hollow or partially hollow. For non time-critical applications where apparatus 10 may under adequate preparation, body 20 may be filled with water, sand and/or other material of adequate density, thus facilitating transport when empty.

The preferred cylindrical shape of body 20 is preferably defined by elongated tube 24. Preferably, base plate 26 is fixably attached to second end 28 of tube 24, preferably via attachment means 44, preferably via welding. Preferably, cover plate 32 is fixably attached to first end 34 of tube 24 via attachment means 40. In the preferred embodiment, attachment means 40 and 44 are welding; however, any suitable means of attachment could be utilized for either attachment means 40 and/or 44.

As depicted in FIGS. 1, 2A, and 3, preferably, handles 46a, 46b, 46c and 46d are carried on body 20, such that handles 46a and 46b are preferably opposingly positioned proximate first end 50 of body 20, and handles 46c and 46d are preferably opposingly positioned proximate second end 54 of body 20. Preferably, handles 46a and 46c are longitudinally aligned relative to one another and body 20, and also preferably, handles 46b and 46d are longitudinally aligned relative to one another and body 20.

Each handle 46a, 46b, 46c and 46d is generally U-shaped, wherein the ‘U’ is defined by first leg 56a, 56b, 56c and 56d, respectively, base leg 60a, 60b, 60c and 60d, respectively, and second leg 62a, 62b, 62c and 62d, respectively. Preferably, base legs 60a, 60b, 60c and 60d are dimensioned to enable comfortable placement of a user's hand thereon, accommodating the width of the user's hand along the length thereof. Preferably first legs 56a, 56b, 56c and 56d and second legs 62a, 62b, 62c and 62d are substantially equal in length, wherein the length thereof is dimensioned to enable comfortable placement of a user's hand between base legs 60a, 60b, 60c and 60d, and body 20.

Although a U-shape is preferred for handles 46a, 46b, 46c and 46d, any suitable shape could be utilized, wherein appropriate support could be realized for body 20 and comfortable receipt of user's hands could be enabled. Additionally, although four handles 46a, 46b, 46c and 46d are preferred, apparatus 10 could have any number of handles, such as, for exemplary purposes only, two handles, for use by one individual, or could have more than four handles, for use by more than two individuals or to enable multiple hand placement selections. Also, although it is preferred that handles 46a, 46b, 46c and 46d are welded to body 20, one skilled in the art would readily recognize that handles 46a, 46b, 46c, and 46d could be integrally formed with body 20, or could otherwise be secured by a fastening means, such as, for exemplary purposes only, via expansion bolts or the like.

Base plate 26 is preferably iron or steel, and preferably generally rectangular-shaped, although it will be recognized that other shapes, such as, for exemplary purposes only, circular, would also serve. Preferably located proximate to base 26 are fillets 68a and 68b, preferably formed of steel or iron, or other suitable material, and preferably secured, such as, for exemplary purposes only, by welding at edges 70a and 70b, respectively, to tube 24, and by welding at bottoms 72a and 72b, respectively, to base plate 26 and body 20, preferably proximate second end 28 of tube 24. Preferably, base surfaces 27 of base plate 26 are preferably flat, whereby upright positioning of apparatus 10 is thereby enabled, and whereby fillets 68a and 68b provide reinforcement support to base plate 26 during such an upright standing position.

Throughhole 76 is preferably defined in cover plate 32 and is dimensioned to permit passage of chain 82 therethrough. Throughhole 76 preferably defines a circular opening; however, any shaped opening appropriately sized for chain 82 could be utilized. Chain 82 is preferably of a length suitable for portability, yet capable of extending round bars during use, wherein a preferred length is approximately eight feet; however, any desirable length could be utilized. Chain 82 is preferably formed from sturdy links capable of transport, wherein five-sixteenth inch chain link is optimum, but any appropriately strong link could be utilized. First end 96 of chain 82 is preferably secured substantially within body 20 via cross-support retention rod 98, wherein link 110 of chain 82 is preferably positioned with cross-support retention rod 98 extending therethrough. Preferably, cross-support retention ports 95a and 95b are defined through body 20, and is dimensioned to receive cross-support retention rod 98 therethrough. In the preferred embodiment, cross-support retention rod 98 is a bolt, preferably secured via nut 112 to retain chain 82. It is contemplated that cross-support retention rod 98 could be secured via locking pins, dual nuts, or via any other appropriate means, and that cross-support retention of chain 82 could be accomplished via any appropriate means, including such means positioned exterior to body 20. That is, chain 82 could be welded to, or in, body 20, or could be affixed via an eye or caribiner-type loop/clip mechanism.

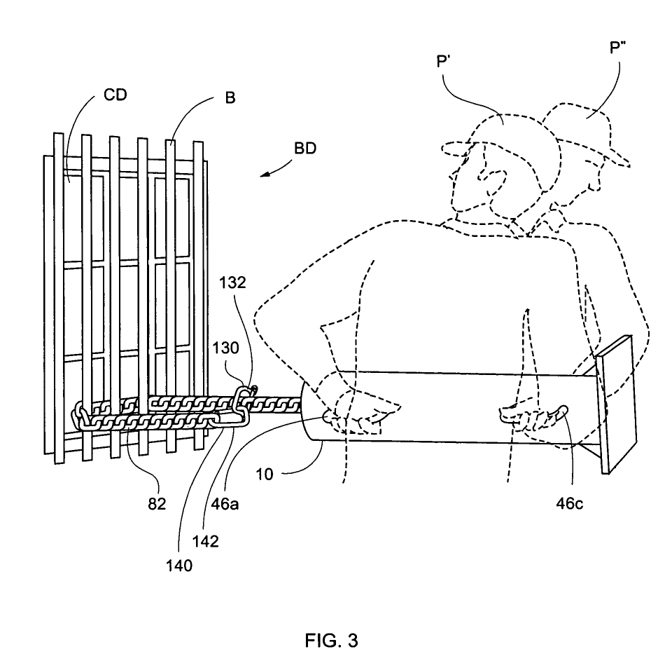

Attachment means 140, such as, for exemplary purposes only, a carabiner 142, is preferably located at second end 114 of chain 82, and is preferably suited for quick attachment and removal of chain 82 from a linked position around a target object such as burglar bars B, as shown in FIG. 3. Chain 82 preferably includes relocatable attachment point means 130, such as, for exemplary purposes only, clevis 132. Preferably, attachment point means 130 is removable and may be positioned at any link 118, particularly at a suitable distance from second end 114 of chain 82 to preferably facilitate passage of second end 114 with carabiner 142, preferably between the bars B of burglar bar door or window BD, preferably allowing carabiner 142 to then be preferably secured to clevis 132.

FIG. 3 depicts apparatus 10 in its preferred use. Apparatus 10 is preferably secured around a selected portion of a burglar bar door or window BD. That is, preferably chain 82 is passed through and between bars B of burglar bar door or window BD and carabiner 142 is preferably secured to clevis 132. First user P′ preferably grips apparatus 10 preferably via handles 46a and 46c. Second user P″ preferably grips apparatus 10 preferably via handles 46b and 46d (best shown in FIG. 1). Users P′ and P″ preferably jointly swing apparatus 10 away from burglar bar door or window BD, preferably causing chain 82 to tighten, thereby preferably pulling burglar bar door or window BD away from its securing frame. As burglar bar door or window BD comes open, it preferably swings away to one side or the other. User P′ (for example the user on the side of burglar bar door or window BD that remains attached), preferably releases his grip on apparatus 10, and then either one or both users P′ and P″ preferably return apparatus 10 towards exposed conventional door or window CD preferably battering conventional door or window CD open to permit entry therethrough.

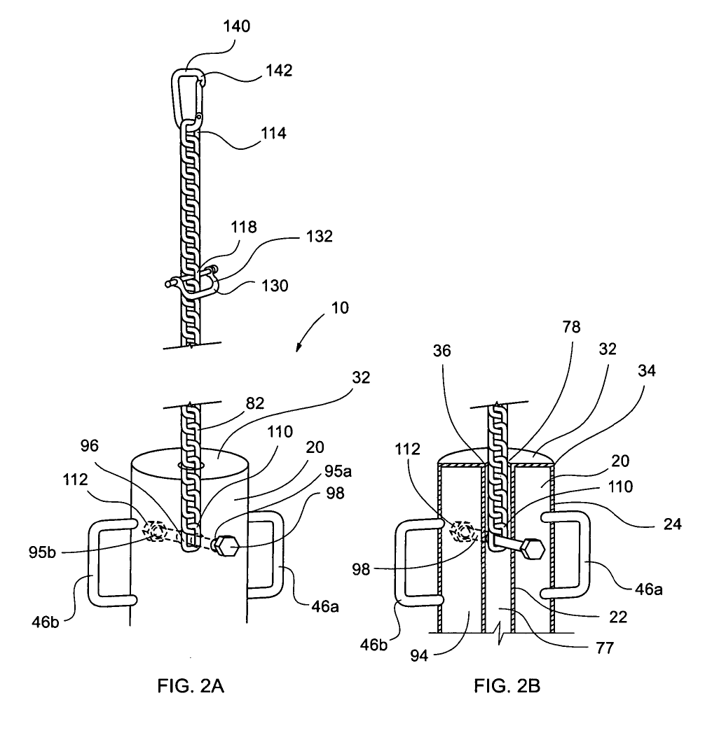

In an alternate embodiment as shown by FIG. 2B, body 20 is made from inner 22 and outer 24 concentric pieces of tubing. In this embodiment, cover plate 32 is fixably attached to first end 34 of outer tube 24 and first end 36 of inner tube 22, wherein cover plate 32 is secured to inner tube 22 and outer tube 24 via attachment means 38 and 40, such as, for exemplary purposes only, via welding. Shaft 77 is defined by inner tube 22 having first opening 78. Shaft 77 is preferably cylindrically-shaped, wherein shaft 77 has a diameter suitable for accommodation of chain 82, wherein shaft 77 functions to reduce the available range of movement of chain 82 within cavity 94 of body 20.

It is contemplated in an alternative embodiment that apparatus 10 could have several chains 82 as part thereof in order to secure in different locations on burglar bar door and/or window BD, or could utilize reinforced steel wire or other such generally flexible and strong material in lieu of, or in addition to, chain 82.

It is contemplated that apparatus 10 could be transported with chain 82 stored subtantially within body 20.

It is envisioned in another alternative embodiment that apparatus 10 could be carried as individual components and assembled in the field by law enforcement, fire or other emergency personnel.

It is contemplated that chain 82 could be any elongated high strength member, such as, for exemplary purposes only, a cable, a wire, a rod, a bar, or any combination or multitude thereof.

It is further envisioned in an alternative embodiment that apparatus 10, in addition to being secured to burglar bar door and/or window BD, could be securely suspended from above and swung from such suspension point.

It is further contemplated that apparatus 10 could be used by one person.

It is also contemplated that handles 46a, 46b, 46c and 46d could have features suitable to facilitate establishing a grip thereon.

In another alternate embodiment, it is contemplated that apparatus 10 may be hollow for facititating transportation and may be filed with a solid or fluid material just prior to use.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing the steps of the method in a certain order does not constitute any limitation on the order of the steps of the method. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

1. A device for removing a work piece comprising:
at least one support body carrying at least one handle thereon;
at least one elongated member;
means for attaching said at least one elongated member to said at least one support body; and
means for removably securing said at least one elongated member to a work-piece.

2. The device of claim 1, wherein said elongated member is a chain.

3. The device of claim 1, wherein said at least one support body comprises a material of high strength selected from the group consisting of iron and steel.

4. The device of claim 1, wherein said at least one support body comprises a generally cylindrically-shaped weighted mass.

5. The device of claim 1, wherein said at least one handle comprises four handles.

6. The device of claim 5, wherein said four handles are comprised of pairs of handles carried approximately diametrically-opposed upon said at least one support body.

7. The device of claim 1, further comprising a base plate carried proximate to a second end of said support body.

8. The device of claim 1, wherein said at least one elongated member is a reinforced wire.

9. The device of claim 1, wherein said at least one elongated member is approximately eight feet in length.

10. The device of claim 1, wherein said means for attaching said at least one elongated member comprises at least one fastening means, and wherein said at least one fastening means is cross-sectionally positioned through said at least one support body and through said at least one elongated member.

11. The device of claim 10, wherein said at least one fastening means comprises at least one bolt and at least one nut, and wherein said at least one nut is secured upon said at least one bolt.

12. The device of claim 1, wherein said means for removably securing said at least one elongated member to a work-piece comprises a carabiner.

13. The device of claim 12, wherein said means for removably securing said at least one elongated member to a work-piece further comprises a clevis.

14. A method for removing burglar bar doors comprising the steps of:
a) obtaining at least one generally elongated mass member;
b) attaching at least one elongated securing member to said generally elongated mass member;
c) removably securing said at least one elongated securing member around at least one bar of a burglar bar set;
d) moving said generally elongated mass member generally away from the burglar bar set; and
e) allowing said at least one elongated securing member to transfer force from mass member to pull the burglar bar set away from a supporting frame.

15. The method of claim 14, further comprising the steps of:
f) moving said generally elongated mass member towards a door; and
g) battering the door.

16. The method of claim 14, wherein said generally elongated mass member is comprised of a metal material.

17. The method of claim 14, wherein said generally elongated mass member carries at least one handle thereon.

18. The method of claim 17, wherein said at least one handle comprises two sets of handles, each said set in longitudinal alignment with said generally elongated mass member, wherein said two sets are positioned diametrically opposite each other.

19. The method of claim 14, wherein said at least one elongated securing member is carried proximate to a first end of said generally elongated mass member, and wherein a base member is carried on a second end of said generally elongated mass member.

20. The method of claim 14, wherein said step of removably attaching said at least one elongated securing member around at least one bar of a burglar bar set further comprises utilizing a carabiner to define a loop-like closure on said at least one chain.

21. An apparatus for removing burglar bars comprising:
at least one cylindrical weighted mass having at least one tunnel therein;
at least one elongated member secured within said at least one tunnel via at least one bolt; and
at least one nut secured to said at least one bolt, wherein said at least one bolt extends through said at least one tunnel in said at least one cylindrical weighted mass.
